(19) United States
(12) Patent Application Publication
(10) Pub. No.: US 2014/0134575 A1
(43) Pub. Date: May 15, 2014

(54) WEARABLE DEVICE TO REPRESENT BRAILLE AND CONTROL METHOD THEREOF

(71) Applicant: SAMSUNG ELECTRONICS CO., LTD, SUWON-SI (KR)

(72) Inventor: Lae-kyoung KIM, Yongin-si (KR)

(73) Assignee: SAMSUNG ELECTRONICS CO., LTD, SUWON-SI (KR)

(21) Appl. No.: 14/078,974

(22) Filed: Nov. 13, 2013

(30) Foreign Application Priority Data
Nov. 15, 2012 (KR) 10-2012-0129811

(51) Int. Cl. G09B 21/02

(52) U.S. Cl. CPC G09B 21/02
USPC 434/114

(57) ABSTRACT

A wearable device in a glove shape that can be worn by a user body includes a motion recognition sensor which recognizes a motion of the wearable device, a bending sensor to sense bending of the wearable device, a touch sensor to sense whether touch is inputted or not, a storage unit to store control codes corresponding to user motion, a controller to determine motion of a user wearing the wearable device based on sensing values of the motion recognition sensor, the bending sensor, and the touch sensor, and to generate control signals by using the control codes corresponding to the determined motion, a communicator which transmits the control signals to a user terminal apparatus and receives data transmitted from the user terminal apparatus in response to the control signals, and an actuator unit which forms a Braille pattern according to the received data.

### CROSS-REFERENCE TO RELATED APPLICATIONS

This application claims priority from Korean Patent Application No. 10-2012-0129811, filed on Nov. 15, 2012, in the Korean Intellectual Property Office, the disclosure of which is incorporated herein by reference in its entirety.

### BACKGROUND OF THE INVENTION

1. Field of the Invention

Apparatuses and methods consistent with what is disclosed herein relate to a wearable device and a control method thereof, and more specifically, to a wearable device which receives data by performing external communication according to user motion and expresses the received data into Braille and a control method thereof.

2. Description of the Related Art

Supportive with development of electronic technologies, various types of electronic apparatuses are invented and disseminated. Therefore, efforts to invent games, music, multimedia contents, and applications that can be used in respective electronic devices are accelerated.

Because the latest terminal apparatuses are implemented with high definition and high performance, various contents and applications may be implemented. Selling prices of such devices are somewhat expensive compared with conventional terminal apparatuses. However, such devices, contents, and applications are generally developed by targeting consumers that do not have body disabilities. Thus, most user interfaces are delivered through the screen.

Users having visual impairments such as blindness have problems of limitedly using functions of a user terminal apparatus regardless of whether they purchase the apparatus with high performance and high definition for an expensive price.

Specifically, while communication is recently performed frequently through phone texts or messenger programs, users having visual impairment may feel difficulty taking advantage of such trends.

Further, as society becomes more complicated, the possibility that users having visual impairment may get lost increases, and the risk on the streets or on the roads becomes higher.

Therefore, a technology is necessary, with which users having visual impairment can utilize their user terminal apparatuses more efficiently to communicate with others and to prevent risk.

### SUMMARY OF THE INVENTION

The present general inventive concept provides a wearable device which communicates with external user terminal apparatuses according to user body motion so that a user having visual impairment can easily control the user terminal apparatuses and a control method thereof.

Additional features and utilities of the present general inventive concept will be set forth in part in the description which follows and, in part, will be obvious from the description, or may be learned by practice of the general inventive concept.

Exemplary embodiments of the present general inventive concept provide a wearable device in a glove shape that can be worn by a user body, the user device including a motion recognition sensor to recognize motion of the wearable device, a bending sensor to sense bending of the wearable device, a touch sensor to sense whether a touch is inputted or not, a storage unit to store control codes corresponding to user motion, a controller to determine a motion of a user wearing the wearable device based on sensing values of the motion recognition sensor, the bending sensor, and the touch sensor, and to generate control signals by using the control codes corresponding to the determined motion, a communicator to transmit the control signals to a user terminal apparatus and receives data transmitted from the user terminal apparatus in response to the control signals, and an actuator unit to form a Braille pattern according to the received data.

The actuator unit may include a plurality of actuators that can be projected, and the actuator unit may form the Braille pattern by selectively projecting an actuator corresponding to the received data from among the plurality of actuators.

The Braille pattern may include one or more Braille characters, and may be formed according to a sliding manner in which each Braille character is consecutively formed and moved toward one direction, or a unit representation manner in which a plurality of the Braille characters are formed in a group.

The wearable device may further include a side, the actuator unit being mounted on the side, and the controller may control the actuator unit to form the Braille pattern when the side on which the actuator unit is mounted touches an outer surface of an object.

The wearable device may further include an output unit to output alarm sounds, and a photographing unit to photograph an outside environment to generate an outside environment image. The controller may determine risk factors based on the outside environment image, and control the output unit or the actuator unit to provide information regarding the determined risk factors.

The wearable device may additionally include a main body formed from flexible materials, the main body including a plurality of finger parts. The bending sensor may be arranged on the plurality of finger parts respectively to sense a bending of each finger part, the touch sensor may be arranged on the plurality of finger parts respectively to sense a touch situation of the finger part, and the actuator unit may be arranged on finger tip parts of in the plurality of finger parts or on a hand palm side of the main body.

The received data may include at least one of a text message, SNS information, e-mail, absent call information, a schedule inform message, and an update message.

The wearable device may additionally include an optical mouse formed on at least one of the finger tip parts. The controller may transmit input signals inputted through the optical mouse to the user terminal apparatus.

Exemplary embodiments of the present general inventive concept also provide a control method of a wearable device in a glove shape that can be worn by a user body, the control method including receiving sensing values of a motion recognition sensor, a bending sensor, and a touch sensor which are mounted on the wearable device, generating control signals based on the sensing values, transmitting the control signals to a user terminal apparatus, receiving data transmitted from the user terminal apparatus in response to the control signals, and forming a Braille pattern corresponding to the data by selectively projecting an actuator corresponding to the data from among a plurality of actuators mounted in the wearable device.

The Braille pattern may include one or more Braille characters, and may be formed according to a sliding manner in which each Braille character is consecutively formed and moved toward one direction or a unit representation manner in which a plurality of the Braille characters are formed in a group.

The Braille pattern may be formed in the wearable device, when a side of the wearable device on which the plurality of actuators is mounted touches an outer surface of an object.

The control method may additionally include photographing an outside environment to generate an outside environment image, determining risk factors based on the generated outside environment image, and providing information regarding the determined risk factors.

The wearable device may include a main body formed from flexible materials and including a plurality of finger parts. The bending sensor may be arranged on the plurality of finger parts respectively to sense a bending of each finger part, the touch sensor may be arranged on the plurality of finger parts to sense a touch situation of the finger, and the plurality of actuators may be arranged on finger tip parts of the plurality of finger parts or a hand palm side of the main body.

A non-transitory computer-readable medium may contain computer-readable codes as a program to execute the control method according to exemplary embodiments of the present general inventive concept.

Exemplary embodiments of the present general inventive concept also provide a wearable device configured to be worn by a user body, the wearable device including a sensor to detect motion of the wearable device and generate a sensor output corresponding to the detected motion, a communication unit to transmit the sensor output to a user terminal apparatus and receive data transmitted from the user terminal apparatus in response to the sensor output, and at least one actuator to form a Braille pattern in response to the data received from the user terminal apparatus.

The wearable device may have the form of at least one of a glove, clothing, a shoe, glasses, and a hat.

The wearable device may further include a controller to determine an elapsed time since the most recent motion of the user was determined, and to deactivate the wearable device if no motion of the user is determined within a preset time.

The wearable device may further include a location determining unit to determine the location of the wearable device. The communicator may transmit the determined location of the wearable device to the user terminal apparatus.

The communicator may transmit the determined location of the wearable device to the user terminal apparatus when no user motion is determined within a preset time.

The wearable device may further include a side, the at least one actuator being mounted on the side, and a controller to control the at least one actuator to form the Braille pattern when the side on which the at least one actuator is mounted touches an outer surface of an object. The controller may generate a user alert if the side on which the actuator unit is mounted does not touch the outer surface of the object within a preset time.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating a wearable device according to an exemplary embodiment of the present general inventive concept;

FIGS. 2A-2B illustrate an exterior constitution of the wearable device implemented in a glove shape according to an exemplary embodiment of the present general inventive concept;

FIG. 3 illustrates types of Braille patterns that can be expressed by using a plurality of actuators;

FIG. 4 illustrates an actuator unit according to an exemplary embodiment of the present general inventive concept;

FIG. 5 is a view explaining detailed constitution and operation principle of one actuator included in the actuator unit;

FIGS. 6A-6E are views explaining a method to express a Braille pattern in a sliding manner;

FIGS. 7A-7B are views explaining a method to express a Braille pattern in a unit representation manner;

FIG. 8 illustrates a driving circuit which drives a plurality of actuators according to an exemplary embodiment of the present general inventive concept;

FIG. 9 illustrates exterior constitution of the wearable device according to another exemplary embodiment of the present general inventive concept;

FIG. 10 is a view explaining a method to sense motion of the wearable device according to an exemplary embodiment of the present general inventive concept;

FIG. 11 illustrates a flexible electrical power source that can be applied to the wearable device according to an exemplary embodiment of the present general inventive concept;

FIG. 12 illustrates an example of a battery which constitutes the electrical power source of the exemplary embodiment of the present general inventive concept illustrated in FIG. 11;

FIG. 13 illustrates a service providing system which includes the wearable device and a user terminal apparatus according to an exemplary embodiment of the present general inventive concept;

FIG. 14 is a block diagram of a user terminal apparatus according to an exemplary embodiment of the present general inventive concept; and

FIG. 15 is a flowchart explaining a control method of the wearable device according to various exemplary embodiments of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

The matters defined in the description, such as detailed construction and elements, are provided to assist in a comprehensive understanding of the present inventive concept. Accordingly, it is apparent that the exemplary embodiments of the present general inventive concept can be carried out without those specifically defined matters. Also, well-known functions or constructions are not described in detail since they would obscure the invention with unnecessary detail.

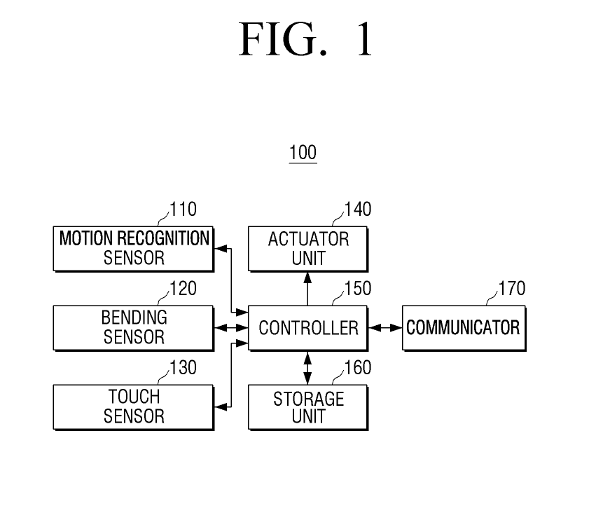

FIG. 1 is a block diagram illustrating a wearable device 100 according to an exemplary embodiment of the present general inventive concept. The wearable device 100 may be formed from flexible materials to be wearable on a user. For example, devices in various forms such as clothes, shoes, gloves, glasses, hats, and accessories that humans or animals can wear on their bodies may be implemented as wearable devices 100. The following exemplary embodiments will describe the wearable device 100 implemented in a glove shape, although the types of wearable devices 100 are not limited to any specific example.

Referring to FIG. 1, the wearable device 100 includes a motion recognition sensor 110, a bending sensor 120, a touch sensor 130, an actuator 140, a controller 150, a storage unit 160, and a communicator 170.

The motion recognition sensor 110 recognizes motion of the wearable device 100. Specifically, the motion recognition sensor 110 may include a gyro sensor, a geomagnetic sensor and an acceleration sensor. Therefore, the motion recognition sensor 110 outputs corresponding sensing values to the controller 150 according to which direction the wearable device 100 rotates or the wearable device 100 moves. Specific sensing methods will be described below.

The bending sensor 120 recognizes bending of the wearable device 100. The bending sensor 120 may be implemented as strain gauge. As described above, because the wearable device 100 may be formed from flexible materials, a user (not illustrated) wearing the wearable device 100 can move in it. For example, when the wearable device 100 is implemented to be a glove shape, a user may perform movements such as clenching their fists or bending their fingers. The bending sensor 120 outputs sensing values corresponding to such movement to the controller 150.

The touch sensor 130 is mounted on a main body 101 of the wearable device 100 and senses whether a user touches. For examples, when the wearable device 100 is implemented to be a glove shape, the touch sensor 130 may be mounted on a finger tip part 103 or a hand palm side 104 of the wearable device 100. Therefore, it may sense that a user touches an object with their finger or palm while wearing the wearable device 100. The touch sensor 130 outputs sensing values to the controller 150.

The storage unit 160 stores operating system (O/S) program, firmware, applications, contents and other data which are needed to drive the wearable device 100. Specifically, the storage unit 160 may store control codes corresponding to user motion.

The controller 150 controls operations of the wearable device 100 by using respective programs and data stored in the storage unit 160. Specifically, the controller 150 may determine movements of a user that wears the wearable device 100 based on sensing values of the motion recognition sensor 110, the bending sensor 120, and the touch sensor 130. When the wearable device 100 is implemented to be a glove shape, the controller 150 may determine whether a user grips or spreads their fist, bends or spreads their fingers, and touches an object (not illustrated) with their fingers. The controller 150 reads control codes corresponding to the determining results from the storage unit 160 and generates control signals including the control codes. Control codes may include digital codes in preset bit numbers.

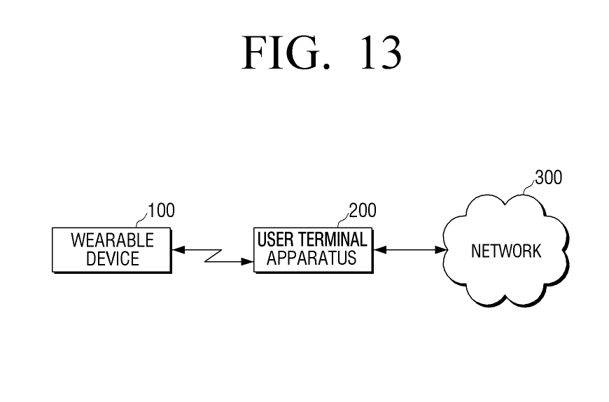

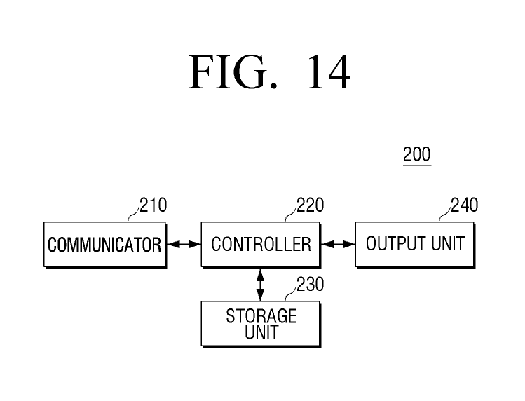

The communicator 170 may transmit the control signals generated in the controller 150 to a user terminal apparatus 200 (illustrated in FIGS. 13-14). The communicator 170 may perform communication with the user terminal apparatus 200 according to various communication methods. Specifically, signals may be generated by wireless communication protocols such as Bluetooth, Zigbee, and WiFi, or may be generated to be IR remote controller signals. According to the applied communication method, detailed constitution of the communicator 170 may be implemented differently. For example, the communicator 170 may include at least one of chips in various types such as a WiFi chip, a Bluetooth chip, a Near Field Communication (NFC) chip, or a wireless communication chip. When a WiFi chip or a Bluetooth chip is used, respective connecting information such as an SSID and a session key may be transmitted and received first with external apparatuses to connect communication, and respective information or commands may be transmitted and received. A wireless communication chip indicates a chip which performs communication according to various communication protocols such as for example IEEE, Zigbee, 3^{rd} generation (3G), 3^{rd} generation partnership project (3GPP), and long term evolution (LTE). Additionally, the communicator 170 may be implemented in a form which includes an IR lamp. The communicator 170 may transmit control signals to external user terminal apparatuses 200 by using the above various communication methods.

A user terminal apparatus 200 may be cellular phone which a user separately carries, a mobile apparatus such as a tablet PC, a laptop PC, or a PDA, or a fixedly mounted apparatus such as a PC, a TV, or a server apparatus. A user terminal apparatus 200 may provide various services by communicating with the wearable device 100.

Specifically, a user terminal apparatus 200 may implement an application according to the control signals applied by the wearable device 100, and transmit data to the wearable device 100 regarding various options that a user can select while implementing the application. Further, when instant messages, e-mails, SNS information, absent call information, schedule notification messages, or update messages are generated separately from the wearable device 100, a user terminal apparatus 200 may transmit such data to the wearable device 100. Thus, a user terminal apparatus 200 may transmit respective information that should be provided to a user while using respective applications installed on the user terminal apparatus 200 to the wearable device 100.

Data transmitted from a user terminal apparatus 200 may be received by the communicator 170. When data is received through the communicator 170, the controller 150 controls the actuator unit 140 to express the data in a Braille pattern.

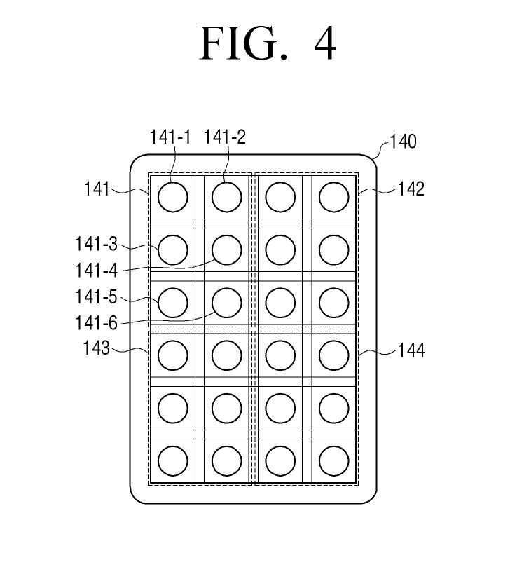

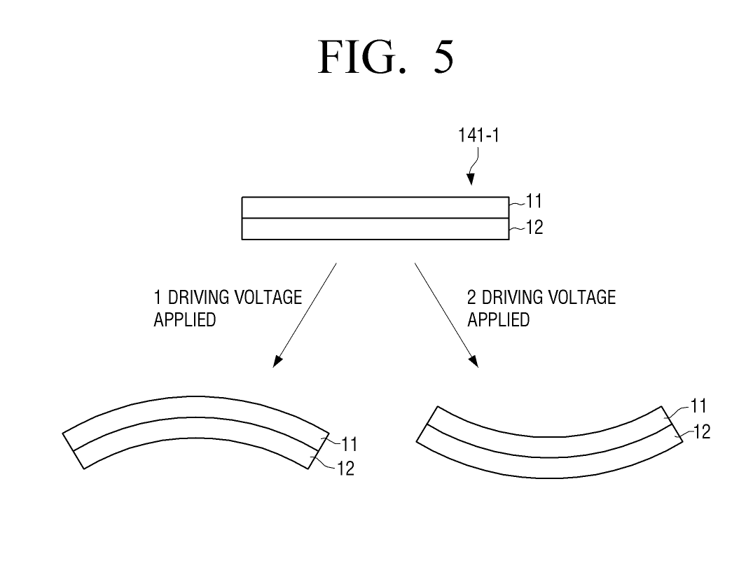

The actuator unit 140 includes a plurality of actuators 141-1, 141-2 . . . 141-x (illustrated in FIGS. 4-5). Each actuator 141-x may be molded up or down according to controlling of the controller 150. Therefore, when a plurality of actuators is used, various Braille patterns may be expressed.

A user can feel a Braille pattern expressed in the actuator unit 140 through their skin, and can recognize the data provided from a user terminal apparatus 200. A user may input intended selecting signals by moving the wearable device 100 according to the recognized data. Thus, even when a user is person having visual impairment, they may utilize respective functions of a user terminal apparatus 200 as they are, with the wearable device 100.

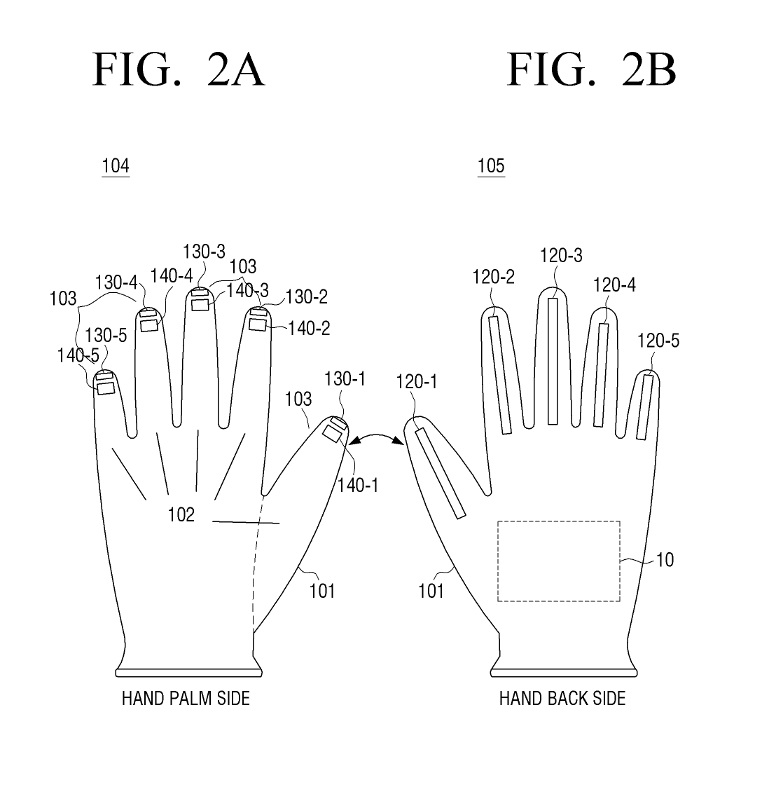

FIGS. 2A-B illustrate the exterior constitution of the wearable device 100 according to an exemplary embodiment of the present general inventive concept. Referring to FIGS. 2A and 2B, the wearable device 100 includes a main body 101 made of flexible materials, and which includes a plurality of finger parts 102. The main body 101 supports the motion recognition sensor 110, the bending sensor 120, the touch sensor 130, the actuator unit 140, the controller 150, the storage unit 160, and the communicator 170.

FIG. 2A illustrates a hand palm side 104 and FIG. 2B illustrates a hand back side 105. Although FIGS. 2A and 2B only illustrate a right hand glove, the wearable device 100 may be implemented as a pair of left and right hand gloves. In this case, the motion recognition sensor 110, the bending sensor 120, the touch sensor 130, the actuator unit 140, the controller 150, the storage unit 160, and the communicator 170 may be distributed and mounted in the main bodies 101 of the left and right hand gloves. The following will explain based on the current exemplary embodiment of the present general inventive concept in which all the above units are arranged in one right hand glove.

Referring to FIG. 2A, the touch sensor 130 may be implemented in plural and arranged in each on end areas within a plurality of finger parts 102, i.e., finger tip parts 103. Each of the touch sensors 130-1-130-5 may be implemented as a resistive touch sensor, capacitive touch sensor, or pressure sensor. Each of the touch sensors 130-1-130-5 provides sensing values corresponding to the touch situation to the controller 150 when the wearable device 100 touches an external object.

Actuator units 140-1-140-5 may be arranged on one side in each of the touch sensors 130-1-130-5. Although FIG. 2A illustrates that the actuator units 140-1-140-5 are arranged on the lower side of the touch sensors 130-1-130-5 respectively, arrangement position may be established variously according to exemplary embodiments of the present general inventive concept. For example, the actuator units 140-1-140-5 may be respectively arranged next to the touch sensors 130-1-130-5 in parallel, or the upper side of the touch sensors 130-1-130-5. Further, instead of the plural actuator units 140-1-140-5, one actuator unit 140 may be implemented and arranged on the hand palm side 104.

FIG. 2B illustrates a hand back side 105 of the wearable device 100. Referring to FIG. 2B, bending sensors 120-1-120-5 may be arranged on the upper side of each finger part 102 in the wearable device 100.

The bending sensors 120-1-120-5 may be implemented as strain gauges. A strain gauge senses modifications in surface of measured object according to changes in resistance values by using metal or semiconductor of which resistance changes greatly by intensity of given power. Usually, regarding materials such as metal, a resistance value of the material increases when the length increases while the resistance value decreases when the length decreases. Referring to FIG. 2B, when each of the bending sensors 120-1-120-5 are arranged on the upper part of the finger part 102, resistance value increases when a user bends their finger to exert a tensile force on the bending sensors 120-1-120-5.

When resistance values of the bending sensors 120-1-120-5 change respectively, electrical signals outputted from the bending sensors 120-1-120-5 change greatly. The controller 150 may determine bending by determining changes in the resistance values of the bending sensors 120-1-120-5. Meanwhile, the bending sensors 120-1-120-5 may be implemented as a piezoelectric sensor or a bend sensor, or other types of sensors as well as a strain gauge.

Further, although FIGS. 2A and B illustrate that one bending sensor 120 is arranged on each finger part 102, the bending sensor 120 may not be arranged on some finger parts 102 or a plurality of the bending sensors 120 may be arranged on one finger part 102.

Meanwhile, various components such as the controller 150, the storage unit 160, and the communicator 170 of the wearable device 100 may be arranged within the wearable device 100 while being mounted on a board 10. Referring to FIG. 2B, the board 10 may be mounted on the hand back side 105; however, it may not be limited to herein. It may be mounted on another location on of the wearable device 100.

The wearable device 100 may provide a Braille pattern by using the actuator unit 140 as described above. Braille expresses characters, fingers or symbols by using defined embossed dots figures, and a user having visual impairment may recognize Braille by using their touch sense.

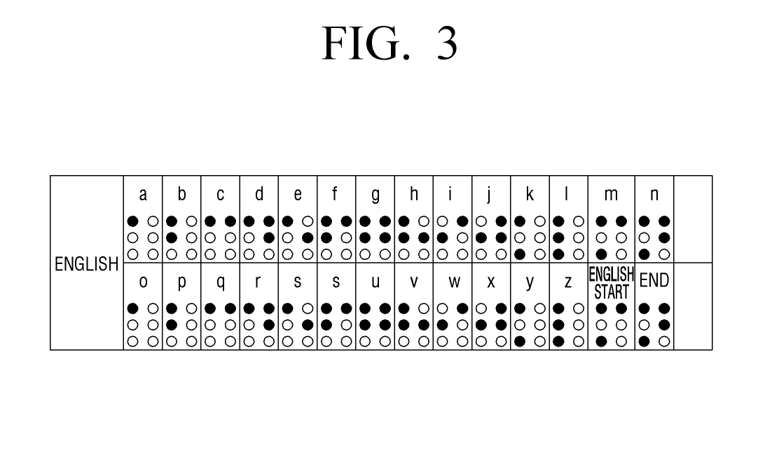

FIG. 3 illustrates Braille patterns corresponding to characters. Referring to FIG. 3, one Braille character may include six dots which are arranged in a 3 line and 2 column matrix. Among six dots, the black dots indicate projected dots, and white circles indicate hole dots or plane dots. Each character is allocated with different dot pattern. A user having visual impairment may distinguish Braille according to the number and position of the projected dots among six dots. Each dot may be implemented by the actuator. Therefore, when the actuator unit 140 in which a plurality of actuator groups 141, 142, 143, 144, 145, and 146 (illustrated in FIGS. 4, 6A-6E, and 7A-7B) are consecutively arranged is used, Braille may be expressed by selectively projecting dots.

Referring to FIG. 4, one actuator unit 140 may be implemented as four actuator groups 141, 142, 143, and 144. One actuator group 141 may include six actuators 141-1-141-6. When four actuator groups 141, 142, 143, and 144 are included as in FIG. 4, the actuator unit 140 may express four characters at once.

Each actuator may have a piezoelectric constitution. Specifically, a piezoelectric constitution may be implemented as various types such as a unimorph type or a bimorph type.

The unimorph type piezoelectric constitution indicates a constitution in which one piezoelectric part is accumulated on metal substrate in a disc shape. The metal substrate and piezoelectric part of the piezoelectric constitution in unimorph type may be implemented respectively as a circle or polygons. The piezoelectric part may include piezoelectric ceramic or piezoelectric polymer. Various types of materials such as PZT, PbTiO₃, or BaTiO₃ may be used for the piezoelectric ceramic. When applying driving signals in a first polar which has greater electric potential on the lower piezoelectric part in the unimorph piezoelectric constitution, the lower piezoelectric part expands. Therefore, it may be modified in a shape which has a boundary area that is molded up and center area is molded down. Meanwhile, when applying driving signals in a second polar which has smaller electric potential on the lower piezoelectric part, it may be modified on the contrary because the piezoelectric part shrinks.

The bimorph type piezoelectric constitution indicates a constitution in which two piezoelectric parts are consecutively accumulated. The piezoelectric parts are accumulated in a form manufactured by printing metallic electrode ashes on ceramic sheet and compressing a plurality of the sheets, including the electrode within them, and sealing the compressed plurality of sheets.

FIG. 5 illustrates an exemplary embodiment of the present general inventive concept in which the first actuator 141-1 is implemented as piezoelectric constitution in bimorph type. Referring to FIG. 5, one actuator 141-1 includes an upper piezoelectric part 11 and a lower piezoelectric part 12. The upper piezoelectric part 11 and the lower piezoelectric part 12 have the feature that they expand when driving signals of the first polar are applied and reduce when opposite driving signals of the second polar are applied. The first polar is positive, the second polar is negative, and the driving signals are voltage wave shaped.

Referring to FIG. 5, when the first driving voltage is applied, the first piezoelectric part 11 expands and the second piezoelectric part 12 shrinks. Therefore, the actuator 141-1 may be bent toward the second piezoelectric part 12. On the contrary, when the second driving voltage is applied, the first piezoelectric part 11 reduces and the second piezoelectric part 12 expands. Thus, the actuator 141-1 may be bent toward the first piezoelectric part 11. Although FIG. 5 illustrates a constitution in which two piezoelectric parts 11 and 12 are accumulated directly, a middle substrate (not illustrated) may be further included between the piezoelectric parts 11 and 12.

The controller 150 controls each actuator 141-1, 141-2 . . . 141-x within the actuator unit 140 to express a Braille pattern corresponding to data which are transmitted from a user terminal apparatus 200. The Braille pattern may be formed in sliding manner in which each Braille character is formed consecutively and moved toward one direction within a plurality of actuator groups 141, 142, 143, and 144, or unit representation manner in which a plurality of Braille characters are formed in a group. Further, although FIG. 4 illustrates that four actuator groups 141, 142, 143, and 144 are arranged in a 2×2 matrix, the number and arrangement of the actuator groups may be determined variously.

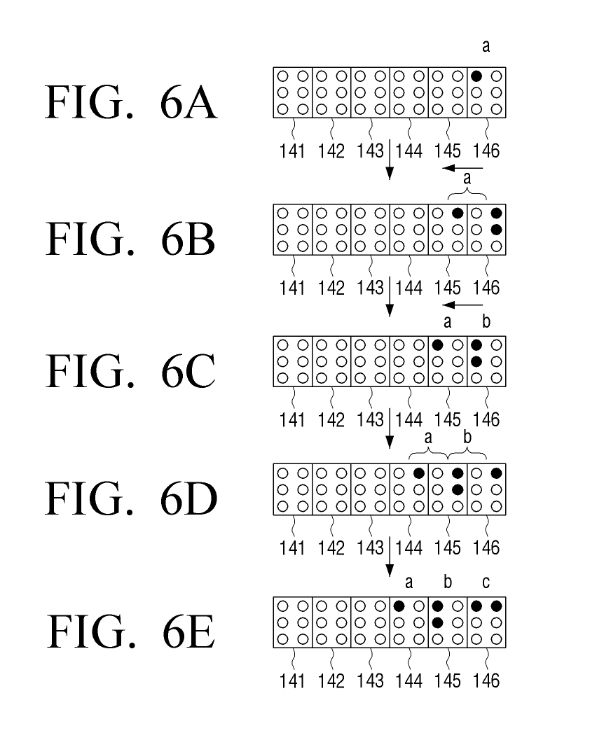

FIGS. 6A-E illustrate a method to express a Braille pattern in sliding manner. Referring to FIGS. 6A-E, one actuator unit 140 may include six actuator groups 141-146. For example, when first, second, and third characters a, b, and c are expressed, first character a, is expressed on the top right actuator group 146, referring to FIG. 6A. First character a is the Braille pattern which an upper left dot is projected among six dots.

Referring to FIGS. 6B-C, the projected pattern is moved in a direction from the sixth actuator group 146 towards the first actuator group 141. While the projected pattern passes through toward the fifth actuator group 145, the Braille pattern to represent the second character, b, is displayed on the top right actuator group 146. FIG. 6B illustrates the characters in transition, e.g. the first character a is displayed half on the fifth actuator group 145 and half on the sixth actuator group 146, while half of the second character b is displayed on the sixth actuator group 146. FIG. 6C illustrates the characters continuing to move towards the first actuator group 141, with the first character a displayed on the fifth actuator group 145 and the second character b displayed on the sixth actuator group 146. Referring to FIGS. 6D-E, while moving in a left direction towards the first actuator group 141, the Braille patterns to express characters a, b, and c are displayed.

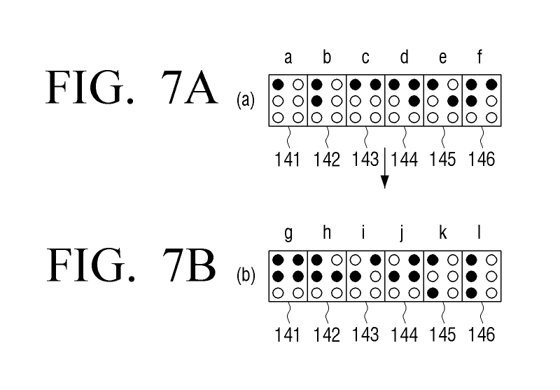

FIGS. 7A and 7B illustrate an exemplary embodiment of the present general inventive concept which a Braille pattern is represented in unit representation manner. Referring to FIGS. 7A and B, the actuator including six actuator groups 141-146 in total is illustrated. Six Braille characters are expressed at once by simultaneously using the actuator groups 141-146. A display time of the Braille characters may be voluntarily established. As in FIG. 7A, the Braille patterns corresponding to characters a, b, c, d, e, and f are displayed and the Braille patterns corresponding to characters g, h, l, j, k, and l are displayed as in FIG. 7B. Likewise, the Braille pattern may be represented based on six units.

Although FIGS. 6A-E, 7A, and 7B illustrate that characters are expressed for convenient explanation, Korean characters, the other foreign characters, numbers, or symbols may be expressed with Braille patterns.

The controller 150 may represent a Braille pattern by using a driving circuit which separately drives six actuators 141-1-141-6 constituting one actuator group 141.

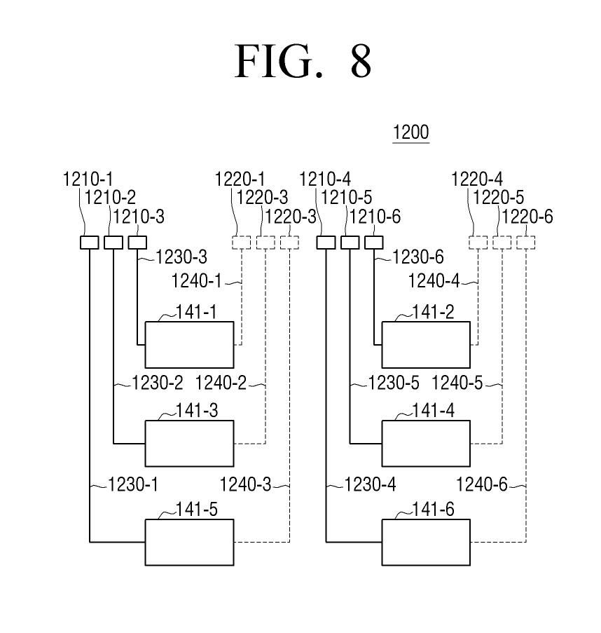

FIG. 8 illustrates an example of an electrode pattern 1200 which drives the actuator group 141. For the purposes of this example, the actuator group is denoted by element 141. It will be understood that this description can apply to any of the above-described actuator groups 141-146.

Referring to FIG. 8, in the electrode pattern 1200, one actuator group 141 includes six actuators 141-1-141-6. Each actuator 141-1-141-6 may have a bar shape or a circular button shape, and each may include the first piezoelectric part 11 and the second piezoelectric part 12 as illustrated in FIG. 5.

Upper circuit lines 1230-1-1230-6 respectively connect each of the actuators 141-1-141-6 to upper electrode pads 1210-1-1210-6.

Further, lower circuit lines 1240-1-1240-6 respectively connect each of actuators 141-1-141-6 to lower electrode pads 1220-1-1220-6.

The controller 150 may apply driving signals to the upper and lower electrode pads 1210 and 1220 which are connected with the respective actuators 141-1-141-6 on the parts to be modified among the upper electrode pads 1210 and the lower electrode pads 1220 in order to locally protrude some parts of the actuator group 141. When the controller 150 applies a first driving signal to one of the actuators 141-1-141-6, for example actuator 141-1, the actuator 141-1 has a projected modification, bending toward an upper side of the actuator group 141. On the contrary, when the controller 150 applies a second driving signal to the actuator 141-1, the actuator 141-1 has a hole modification in which the surface of the actuator 141-1 is fallen while bending toward a lower side of the actuator group 141.

Meanwhile, the actuator unit 140 may perform the function of providing vibration feedback as well as the function forming a Braille pattern. In this case, the controller 150 may generate vibration effects by applying electrical current voltage to both ends of at least one of the actuators 141-1-141-6 or by alternately and repeatedly applying the first and second driving signals within a short time. Vibration feedback may be provided when a new message is received from a user terminal apparatus 200 or when a user does not make any motion over a preset time.

When the actuators 141-1-141-6 are constituted in a bar shape, it may design that modification can be performed on unfixed parts while one ends or both ends of the actuators 141-1-141-6 are fixed to the plate. For example, when one ends of the actuators 141-1-141-6 is fixed, the other ends may be bent toward an upper direction or a lower direction. Further, when both ends of the actuators 141-1-141-6 in a bar shape are fixed, the center of the actuators 141-1-141-6 may be bent to project toward an upper direction or bent toward a lower direction.

The controller 150 may decode and convert data received from a user terminal apparatus 200 into text format, confirm information regarding a Braille pattern corresponding to each text, and a form requested the Braille pattern by applying driving signals to each actuator 141-x according to the information.

Meanwhile, the Braille pattern is recognized by touch sense of a user. Therefore, the Braille pattern cannot be recognized conveniently when the wearable device 100 does not closely contact a user body. Therefore, the controller 150 may control whether to form the Braille pattern based on results of the touch sensor 130.

Even when an event for which a Braille pattern needs to be formed occurs, the controller 150 may not form the Braille pattern immediately, and may stand by until the side of the wearable device 100 within which the actuator unit 140 is arranged touches an outer surface of an object (not illustrated). Received data or another event situation may be stored in the storage unit 160 until a touch is performed. At this step, when the side of the wearable device 100 where the actuator unit 140 is arranged touches the outer surface of an object, the controller 150 controls the actuator unit 140 to form the Braille pattern. In this case, data which are accumulated and stored in the storage unit 160 can be represented consecutively in the Braille pattern. Therefore, it may clearly deliver the Braille pattern in a situation when a user can easily recognize the Braille pattern. When a touch situation does not occur for more than a preset time even though an event occurs for which the Braille pattern should be formed, the controller 150 may suggest a user to touch an object by outputting vibration feedback or making alarm sounds.

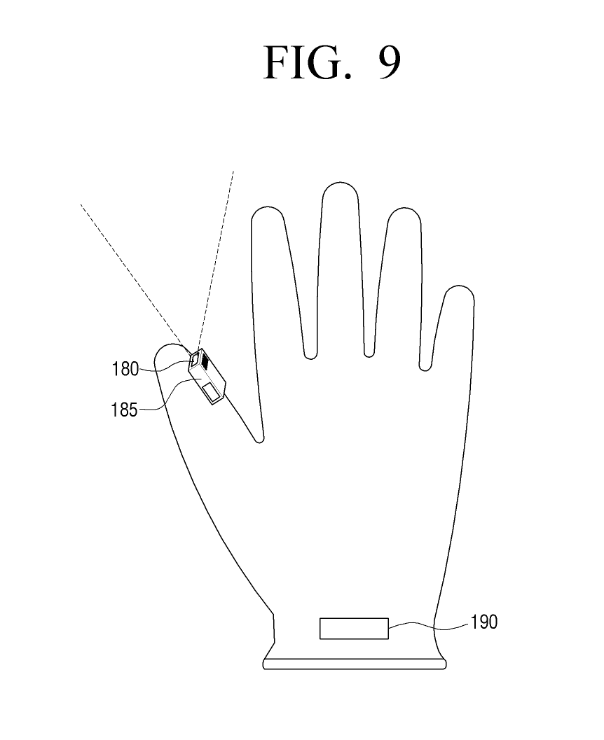

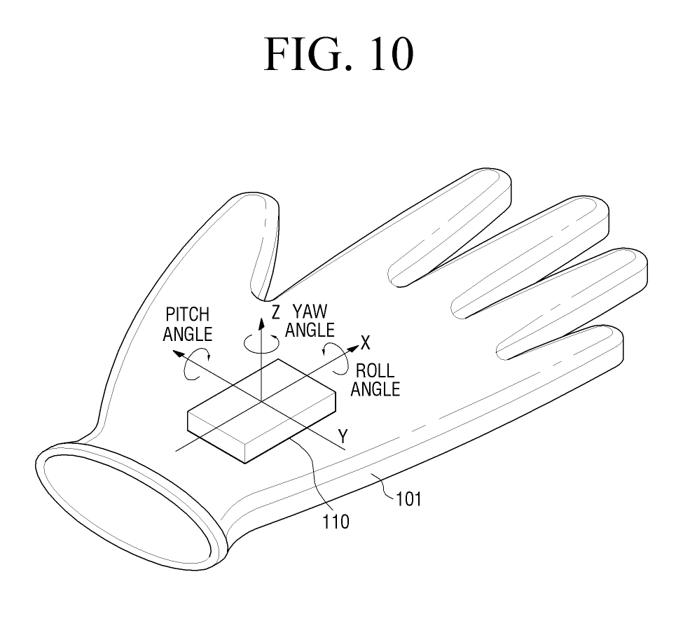

Meanwhile, according to another exemplary embodiment of the present general inventive concept, the wearable device 100 may further include various additional sensors as necessary, described below with reference to FIGS. 9 and 10.

FIG. 9 illustrates a constitution of the wearable device 100 according to another exemplary embodiment of the present general inventive concept. Referring to FIG. 9, the wearable device 100 may further include a photographing unit 180, an optical mouse 185, and an output unit 190.

The photographing unit 180 photographs an outside environment. The photographing unit 180 may be implemented as a camera module which includes a lens and an image sensor (not illustrated). A conventionally used lens, optical lens, or zoom lens may be used for the lens. A complementary metal oxide semiconductor (CMOS) or a charge coupled device (CCD) may be used for the image sensor. Furthermore, although FIG. 9 illustrates that one photographing unit 180 is included on a thumb of the finger parts 102 of the wearable device 100, the photographing unit 180 may be included on the hand back side 105 or other finger parts 102, and may be implemented in plural.

The photographing unit 180 provides a photographed outside environment image (not illustrated) to the controller 150. The controller 150 may perform various controlling operations based on the photographed outside environment image in the photographing unit 180.

For example, the controller 150 may determine risk factors in the surrounding area by analyzing the photographed image. Specifically, the photographing unit 180 may provide a plurality of outside environment images to the controller 150 by consecutively photographing on a several ms basis or a several second basis. The controller 150 divides each of the outside environment images on a pixel block basis, and confirms representative pixel values in each pixel block. After confirming, when representative pixel values having a similar range are created consecutively, the controller 150 may recognize that the pixel blocks having the representative pixel values constitute one object. The controller 150 recognizes objects with the same method regarding outside environment images photographed subsequently. By comparing the number of pixel blocks corresponding to the recognized object, it recognizes whether the object is approaching the user or going away. The controller 150 may determine a risky situation when surrounding objects approach toward a direction of the wearable device 100 at more than a preset speed. Further, when a sign light, such as a traffic light, is included in the photographed images, the controller 150 may determine a risky situation by recognizing the color displayed on the sign light.

When the controller 150 determines a risky situation in which a risk is observed, the controller 150 may inform a user of the wearable device 100 regarding the risky situation. Specifically, vibration feedback may be provided by controlling the actuator unit 140 or a Braille pattern may be formed to inform the user of the risky situation. Further, alarm sounds may be provided by controlling the output unit 190. Meanwhile, although FIG. 9 illustrates that a risky situation is determined by only using the photographing unit 180, additional sensors such as an approach recognition sensor (not illustrated) which senses whether surrounding objects approach by using ultrasonic waves may be included to determine a risky situation.

The output unit 190 outputs respective audio signals according to controlling of the controller 150. The output unit 190 may output texts within the data received from the user terminal apparatus 200 in voice signal form as well as providing alarm sounds to inform the user of the risky situation. Although FIG. 9 illustrates that the output unit 190 is arranged on a wrist part of the wearable device 100, the position of the output unit 190 may be varied. Further, the output unit 190 may be implemented in a jack form which connects to earphones or headphones, instead of as a speaker. According to the exemplary embodiment of the present general inventive concept including the output unit 190, a user may confirm data of a user terminal apparatus 200 by using voice signals with a Braille pattern that are provided through the actuator unit 140.

For another example, the photographing unit 180 may be used in recognizing user motion. When a user uses the photographing unit 180 to photograph characters or drawings after writing or drawing on a paper, the controller 150 may recognize the characters or the drawings by analyzing the photographed image. The controller 150 may store the recognized results in the storage unit 160 or transmit the recognized results to a user terminal apparatus 200.

Meanwhile, when the optical mouse 185 is arranged separately from the photographing unit 180, user motion may be recognized by using the optical mouse 185.

The optical mouse 185 is unit that determines which direction the optical mouse 185 moves by emitting light signals with an emitting device (not illustrated) formed on a lower side of the optical mouse 185 and by recognizing shape of the ground after receiving the reflecting lights.

Although FIG. 9 illustrates that the optical mouse 185 and the photographing unit 180 are formed as a single unit, the optical mouse 185 is not necessarily formed with the photographing unit 180, and may be arranged on the finger parts 102 or the hand palm side 104. The optical mouse 185 may be used to input control signals of the user. In other words, when the optical mouse 185 is arranged near on the finger tip part 103 of the finger parts 102 and a user writes or draws characters or drawings on the ground by using the finger, user intention may be confirmed by recognizing traces of user motion. With such a method, the wearable device 100 may transmit proper answering signals regarding a user terminal apparatus 200. When a text message or an e-mail is received through a user terminal apparatus 200 and the wearable device 100 provides it to the user in a Braille pattern, the user may write a reply on the ground with the finger that the optical mouse 185 is arranged on. In this case, the optical mouse 185 may recognize and provide motion of the user finger to the controller 150, and the controller 150 may recognize the user reply. The controller 150 may transmit the recognized reply to a user terminal apparatus 200.

Additionally, when a cursor is displayed on a user terminal apparatus 200, the controller 150 may transmit a command to move the cursor according to the recognized results of the optical mouse 185. In this fashion, the wearable device 100 may operate as a wireless mouse.

Meanwhile, the wearable device 100 may sense user motion by using the motion recognition sensor 110. The motion recognition sensor 110 may include an acceleration sensor, a gyro sensor, and a geomagnetic sensor (not illustrated).

The acceleration sensor is sensor which senses a gradient degree by using gravity. When a gravity value is 1 g when sensing toward a vertical direction, a value less than 1 g is measured when the acceleration sensor tilts a little, and 1 g is measured when the acceleration sensor stands reversely, that is, when it is rotated 180 degrees. The acceleration sensor may output pitch angle and roll angle by using the above principle. A two-axis fluxgate or a three-axis fluxgate may be used for the acceleration sensor. When the wearable device 100 is implemented to be a glove shape, it may be inconvenient to use when the acceleration sensor has large size. Thus, in the present exemplary embodiment of the present general inventive concept, it may be implemented as a two-axis acceleration sensor 111 which uses two fluxgate sensors (not illustrated) vertically crossed with each other.

The gyro sensor uses a gyroscope to detect rotation of a body the gyroscope is mounted in. A spinning gyroscope maintains its spin axis direction regardless of the orientation of a body it is mounted in, with regard to at least one axis. As such, a gyro sensor can be used to determine how far the body has rotated with regard to the at least one axis. A gyro sensor mounted in the wearable device 100 therefore can determine rotation of the wearable device along at least one axis.

The geomagnetic sensor is device which measures intensity and direction of the Earth's magnetic field. Specifically, the geomagnetic sensor using a fluxgate is a fluxgate type geomagnetic sensor. The geomagnetic sensor may be implemented as two-axis or three-axis fluxgate sensor like in the acceleration sensor.

FIG. 10 is a view explaining motion types that can be sensed by using the motion recognition sensor 110. Referring to FIG. 10, when the motion recognition sensor 110 is mounted within the main body 101 of the wearable device 100, X, Y, Z axes which are vertically crossed with each other are determined according to arrangement direction of the fluxgate. Pitch angle indicates rotating angle which is measured when rotating based on X axis, and roll angle indicates rotating angle which is measured when rotating based on Y axis. Yaw angle indicates rotating angle which is measured when rotating based on Z axis. Pitch angle and roll angle may be measured by the acceleration sensor and yaw angle may be measured by the geomagnetic sensor or the gyro sensor.

The controller 150 may sense changes in pitch angle, roll angle, and yaw angle by using the acceleration sensor, the geomagnetic sensor or the gyro sensor, and determine movements of the wearable device 100 according to the sensed results.

Pitch angle and roll angle may be calculated by using outputted values of the acceleration sensor. Specifically, the controller 150 may perform normalization processing which maps outputted values from the X axis acceleration sensor and Y axis acceleration sensor to outputted values having a certain range. For example, normalization may be performed according to the following mathematical formula.

$${Xt}_{norm} = \frac{2 Xt - ( {Xt}_{max} + {Xt}_{min} )}{{Xt}_{max} - {Xt}_{min}} \\ {Yt}_{norm} = \frac{2 Yt - ( {Yt}_{max} + {Yt}_{min} )}{{Yt}_{max} - {Yt}_{min}} \qquad [ Formula 1 ]$$

where Xt is an outputted value of the X axis acceleration sensor, Yt is an outputted value of the Y axis acceleration sensor, Xtₙₒᵣₘ is a normalized outputted value of the X axis acceleration sensor, and Ytₙₒᵣₘ is a normalized outputted value of the Y axis acceleration sensor.

When normalization is performed, the controller 150 may calculate pitch angle θ and roll angle φ by using the following mathematical formula.

$$θ = {sin}^{- 1} ( {Xt}_{norm} ) \\ φ = {sin}^{- 1} ( \frac{{Yt}_{norm}}{cos θ} ) \qquad [ Formula 2 ]$$

where Xtₙₒᵣₘ is a normalized outputted value of the X axis acceleration sensor, Ytₙₒᵣₘ is a normalized outputted value of the Y axis acceleration sensor, θ indicates pitch angle, and φ indicates roll angle.

Meanwhile, the geomagnetic sensor may be implemented as similar constitution to the acceleration sensor. First, the controller 150 normalizes outputted values of X axis and Y axis fluxgates within the geomagnetic sensor by using the following mathematical formula.

$${Xf}_{norm} = \frac{( Xf - {Xf}_{bias} )}{{Xf}_{sf}} \\ {Yf}_{norm} = \frac{( Yf - {Yf}_{bias} )}{{Yf}_{sf}} * α \\ {Xf}_{bias} = \frac{{Xf}_{max} + {Xf}_{min}}{2} , {Xf}_{sf} = \frac{{Xf}_{max} - {Xf}_{min}}{2} \\ {Yf}_{bias} = \frac{{Yf}_{max} + {Yf}_{min}}{2} , {Yf}_{sf} = \frac{{Yf}_{max} - {Yf}_{min}}{2} \qquad [ Formula 3 ]$$

where Xf and Yf are outputted values of X axis and Y axis geomagnetic sensors respectively, Xfₙₒᵣₘ and Yfₙₒᵣₘ are normalized values of X axis and Y axis respectively, Xfₘₐₓ and Xfₘᵢₙ are maximum and minimum values of Xf respectively, and Yfₘₐₓ and Yfₘᵢₙ are maximum and minimum values of Yf respectively. Although not described in Formula 3, voluntarily established constants may be additionally multiplied to each of the normalized values.

The controller 150 may calculate a direction where the motion recognition sensor 110 is mounted, i.e., azimuth α in a three dimensional (3D) area by using the normalized values. Because azimuth is a 3D value which are expressed with three axes, calculating an azimuth α needs an outputted value of Z axis orthogonal to the plane which X axis and Y axis constitutes. However, when the two-axis fluxgate is included, an outputted value of Z axis cannot be calculated directly. Thus, virtual calculation is performed. The controller 150 may calculate a virtual normalized outputted value of Z axis by applying the normalized values regarding the outputted values of X axis and Y axis, pitch angle θ, roll angle φ, and dip angle λ to the following mathematical formula.

$${Zf}_{norm} = \frac{( {Xf}_{norm} * sin θ - {Yf}_{norm} * cos θ * sin φ + sin λ}{cos θ * cos φ}$$

where Zf is a voltage value of virtual Z axis, Zfₙₒᵣₘ is a normalized value regarding the voltage value of Z axis, λ indicates dip angle, θ indicates pitch angle and φ indicates roll angle.

When the normalized values regarding the voltage values of virtual Z axis are calculated according to the above, azimuth α may be finally calculated by using the following mathematical formula.

$$α = {tan}^{- 1} ( \frac{{Zf}_{norm} * sin φ - {Yf}_{norm} * cos φ}{{Xf}_{norm} * cos θ + {Yf}_{norm} * sin θ * sin φ + {Zf}_{norm} * sin θ * cos φ} )$$

Herein, α indicates azimuth, Xfₙₒᵣₘ, Yfₙₒᵣₘ, and Zfₙₒᵣₘ are normalized outputted values of X axis, Y axis, and Z axis fluxgates respectively, θ indicates pitch angle, and φ indicates roll angle.

The controller 150 may determine which direction and the angle the wearable device 100 rotates by comparing the azimuth calculated with the geomagnetic sensor and the azimuth previously calculated. When the previous azimuth is a and the current azimuth is α+30, it may determine that rotation has been performed clockwise by 30°. Further, the controller 150 may determine which direction and by how much angle the wearable device 100 tilts according to changes in the pitch angle θ and the roll angle φ calculated in the acceleration sensor.

As a result, the controller 150 may recognize user motion by combining sensing values from the bending sensors 120-1-120-5 and the motion recognition sensor 110 which are mounted on the finger parts 102.

For example, regarding the wearable device 100 illustrated in FIG. 2, when the second bending sensor 120-2 has no changes in resistance values and the other bending sensors 120-1, 120-3-120-5 sense bending, the controller 150 determines that the second finger spreads while the other fingers bend. With the above, when the pitch angle θ sensed in the motion recognition sensor 110 changes, the controller 150 determines whether the finger bends to point the ground or to point the sky according to signs of the pitch angle θ. While the wearable device 100 tilts toward a direction that the finger points the ground, when azimuth α of the motion recognition sensor 110 changes, the controller 150 determines which direction the wearable device 100 moves according to the azimuth α. Thereby, the controller 150 determines motion of a user that wears the wearable device 100 by combining sensing results regarding pitch angle θ, roll angle φ, azimuth α, and bending. Further, the controller 150 determines hand fist situation when all of the bending sensors 120-1-120-5 are sensed to be bent, and hand spread situation when they are sensed to be spread. The controller 150 determines motion based on the sensing values of the motion recognition sensor 110 while this situation.

The controller 150 may generate input signals corresponding to the determined motion and transmit to a user terminal apparatus 200 through the communicator 170.

When specific motion occurs, the controller 150 may control operations of the wearable device 100 according to the motion. For example, when a preset start motion occurs, the controller 150 may perform activating of each unit within the wearable device 100. Next, the controller 150 may transmit input signals to a user terminal apparatus 200 by sensing motion with each sensor of the wearable device 100, and control the actuator unit 140 according to the data transmitted from a user terminal apparatus 200.

When the controller 150 determines that preset finish motion occurs, it may complete control mode regarding a user terminal apparatus 200. In this case, the controller 150 may inactivate all the other units than the sensors 110, 120, and 130, to sense the start motion among the sensors 110, 120, 130 and the actuator unit 140. Further, the controller 150 may complete a control mode when no motion is sensed for a preset time. Thereby, electrical power consumption may be saved when it is unnecessary.

A start motion or a finish motion may be voluntarily established and stored in the storage unit 160. For example, various motions such as the motion of forming fists and spreading the fingers more than a certain number of times, the motion of both hand palms, the motion of drawing a specific figure in the air while spreading the hand palm, and the motion of forming fists tightly, may be used for the start motion or the finish motion.

Meanwhile, as described above, because the wearable device 100 should be worn by a user body, it has flexible features. Therefore, the number of units having solid features should be reduced as much as possible.

According to an exemplary embodiment of the present general inventive concept, an electrical power source which provides electrical power to each unit of the wearable device 100 may be manufactured and used in flexible materials.

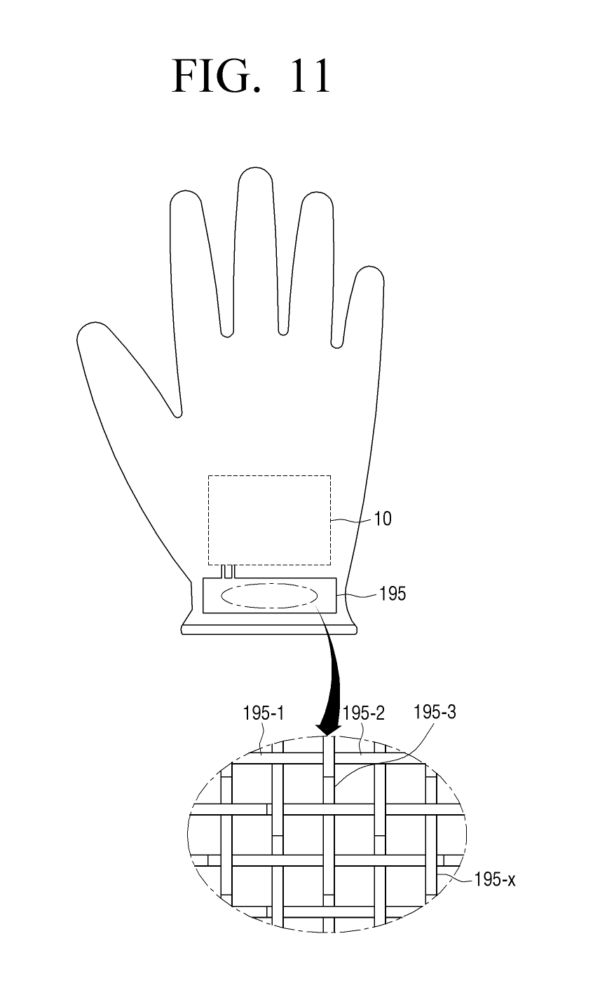

FIG. 11 illustrates an example of the wearable device 100 which includes the electrical power source in flexible materials. Referring to FIG. 11, the wearable device 100 further includes the electrical power source 195 which is mounted within the main body 101 and provides electrical power that each unit uses. The electrical power source 195 connects to the board 10, and the controller 150 may switch operation providing electrical power to each unit through an electrical power providing circuit on the board 10. Specifically, in order to minimize battery consumption, when not in use, the controller 150 may shield electrical power that is applied to respective units including the motion recognition sensor 110, the bending sensor 120, the touch recognizer sensor 130, the actuator unit 140, the communicator 170, and the storage unit 160, or turn off the respective units by applying reduced electrical power, i.e., standby electrical power. In a shielding or inactivating situation, when a specific program is executed in an external apparatus 200, the wearable device 100 recognizes the start motion, or a button to turn the apparatus on is operated, the controller 150 may activate each unit. Specifically, the controller 150 may determine user motion by activating the motion recognition sensor 110, the bending sensor 120, and the touch sensor 130.

The electrical power source 195 may include a general instant battery or a recharging battery. Further, the electrical power source 195 may include flexible materials to be suitable for features of the main body 101. FIG. 11 illustrates that a plurality of line batteries 195-1, 195-2, 195-3-195-x connect in series to form one line, and a texture is manufactured by crossing the lines with each other.

Although FIG. 11 illustrates that the electrical power source 195 is mounted on some part of the main body 101 in the wearable device 100, whole of the main body 101 may be implemented as electrical power source 195. Referring to FIG. 11, a glove shape of texture structure to support the units such as respective sensors or the controller 150 may be manufactured by connecting a plurality of line batteries 195-1-195-x having flexible features.

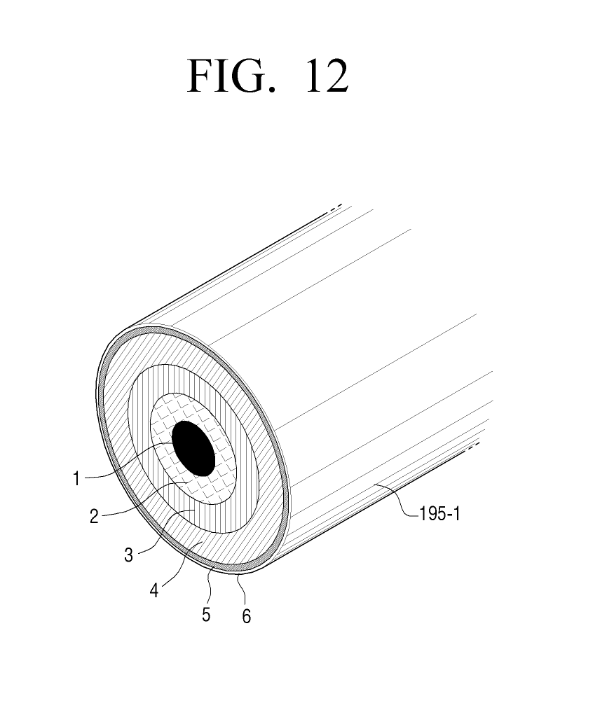

FIG. 12 illustrates an example of inner structure of one line battery 195-1. Referring to FIG. 12, the line battery 195-1 is implemented as a constitution which an inner electrical collector 1, an inner electrode 2, an electrolyte 3, an outer electrode 4, an outer electrical collector 5, and a covered part 6 are consecutively arranged from the inner side. The inner electrical collector 1 may be implemented with alloyed metal such as TiNi group having good elastic features, carbon fiber, or other conductive polymer. Surface of the inner electrical collector 1 is covered with the inner electrode 2. The inner electrode 2 may be implemented with various types of materials according to electrode features. When the inner electrode 2 is used as a negative electrode, it may be manufactured with negative electrode materials such as Lithium or Na. In this case, the outer electrode 4 may be manufactured with positive electrode materials such as sulfur and metal sulfide because it is used as a positive electrode. It may be implemented on the contrary when the inner electrode 2 is used as the positive electrode and the outer electrode 4 is used as the negative electrode. Surface of the inner electrode 2 is covered with the electrolyte 3. The electrolyte 3 physically separates between the inner electrode 2 and the outer electrode 4 so that ion transmission between the two electrodes can be performed. The electrolyte 3 may be constituted in various types such as gel type, porous type, or solid state type. The outer electrode 4 is arranged on the exterior of the electrolyte 3, and the outer electrical collector 5 is arranged on the exterior of the outer electrode 4. The outer electrical collector 5 may be manufactured with various types of materials as in the inner electrical collector 1. The covered part 6 is formed on the exterior of the outer electrical collector 5. The covered part 6 may be manufactured by using conventional polymer resin. For example, PVC or epoxy resin may be used. Besides, when materials can be curved or bent freely while preventing broken damage of the battery 195-1 in fiber format, it may be used as covered part 6. Because the battery constitution of FIG. 12 is merely one exemplary embodiment of the present general inventive concept, it may not be limited to herein.

As described above, while being worn on a user body, the wearable device 100 may provide various services according to the programs implemented in a user terminal apparatus 200 to a user by performing communication with the user terminal apparatus 200.

FIG. 13 illustrates a constitution of a service providing system which includes the wearable device 100 and the user terminal apparatus 200 according to an exemplary embodiment of the present general inventive concept.

Referring to FIG. 13, the wearable device 100 transmits various control signals according to movements or touches of a user that wears the device 100 to the user terminal apparatus 200. The user terminal apparatus 200 may transmit various data according to the control signals of the wearable device 100.

For example, when a user wears the wearable device 100, then makes the start motion or pushes a button to turn the wearable device 100 on, the wearable device 100 establishes communication with the user terminal apparatus 200. Communication may be established through a wire or wireless interface.

When connecting to the wearable device 100, the user terminal apparatus 200 automatically converts to the control mode which is controlled by the wearable device 100. Under the control mode, when data such as a phone call, e-mail, SNS message, or text message is received through a network 300, the user terminal apparatus 200 delivers the received data to the wearable device 100.

In this case, the user terminal apparatus 200 may convert and provide the data in a form that can be recognized by the wearable device 100. Specifically, the user terminal apparatus 200 may detect and provide information regarding text, excepting data regarding objects that cannot be represented in a Braille pattern, e.g., image, picture, and layout information, for example.

According to the input signals transmitted from the wearable device 100, the user terminal apparatus 200 may perform communication with server devices or other user terminal apparatuses 200, such as server devices or databases (not illustrated), which are connected with the network 300. For example, when motion matched with searching movements is sensed in the wearable device 100 or searching words are recognized according to user motion, the wearable device 100 may transmit searching words and searching commands to the user terminal apparatus 200. The user terminal apparatus 200 may search data corresponding to the searching words from respective server devices or databases that are connected through the network 300 and provide to the user terminal apparatus 200.

Meanwhile, when the wearable device 100 further includes a GPS chip, the wearable device 100 may transmit its position to the user terminal apparatus 200 in real time. The user terminal apparatus 200 may include preset devices which can provide the position of the wearable device 100 in real time. These preset devices may include for example server devices that an emergency center or managing center (not illustrated) uses, or alternatively may be a user terminal apparatus of the user's parents or other caretaker.

Further, when user motion is not sensed for more than a preset time even though the wearable device 100 is turned on, an unusual motion is sensed, or a request of the position regarding the wearable device 100 is received from other devices (not illustrated) connected to the network 300, the user terminal apparatus 200 may provide the position of the wearable device 100. Therefore, even when a user having visual impairment meets an unexpected accident, rescue of the user can be performed more swiftly.

Meanwhile, when the wearable device 100 and the user terminal apparatus 200 do not include GPS chips, it may be implemented according to an exemplary embodiment of the present general inventive concept that the position of the wearable device 100 is calculated by using the motion recognition sensor 110 such as the geomagnetic sensor or a walking counter sensor (not illustrated) that is mounted on the wearable device 100. As described above, when there is possibility that a user may face a risk, the user terminal apparatus 200 may inform other devices of the risk that a user faces by providing the calculated position of the user to the other devices.

FIG. 14 is a block diagram of the user terminal apparatus 200 according to an exemplary embodiment of the present general inventive concept. Referring to FIG. 14, the user terminal apparatus 200 includes a communicator 210, a controller 220, a storage unit 230, and an output unit 240.

The communicator 210 performs communication with the wearable device 100 or other devices (not illustrated) on the network 300. The communicator 210 may perform communication according to at least one communication method among various communication methods such as WiFi, Bluetooth, Zigbee, IEEE, 3G, or 4G.

The output unit 240 outputs implementing screen regarding respective programs performed in the user terminal apparatus 200 or messages.

The storage unit 230 stores respective programs or data necessary to use the user terminal apparatus 200.

The controller 220 controls operation of the user terminal apparatus 200 by implementing respective programs stored in the storage unit 230. Specifically, the controller 220 converts to the control mode when the wearable device 100 connects to the user terminal apparatus 200 through the communicator 210. In the control mode, the user terminal apparatus 200 may perform an operation only according to the control signals transmitted from the wearable device 100 without requiring user commands inputted through a touch screen or a button of the user terminal apparatus 200.

When various control signals are transmitted from the wearable device 100 in the control mode, the controller 220 performs a controlling operation by implementing a program or contents corresponding to the control signals.

Further, when there is a message to be outputted through the output unit 240, the controller 220 may convert the message to data in a form that can be recognized by the wearable device 100 and transmit the converted data to the wearable device 100 through the communicator 210.

Additionally, when there is no response from the wearable device 100 over a certain time, or unusual control signals are transmitted continuously, informing signals including the position of the wearable device 100 or the user terminal apparatus 200 may be transmitted to other previously registered devices (not illustrated).

When the user terminal apparatus 200 is implemented as a TV, the controller 220 may receive remote controller signals from the wearable device 100 and control TV operation according to the remote controller signals. In this case, the wearable device 100 may further include an IR lamp.

Meanwhile, the above exemplary embodiments describe that the controller 150 of the wearable device 100 determines user motion based on movements of the sensors, and transmits control signals according to the determining results to the user terminal apparatus 200; however, it may not be limited to herein. The wearable device 100 may transmit sensing values as they are directly to the user terminal apparatus 200. In this case, the controller 220 of the user terminal apparatus 200 may recognize control signals based on the sensing values and perform controlling operations corresponding to the control signals.

Besides, the operation and constitution of the user terminal apparatus 200 may be implemented variously according to product types. However, related specific illustration and explanation will not be included.

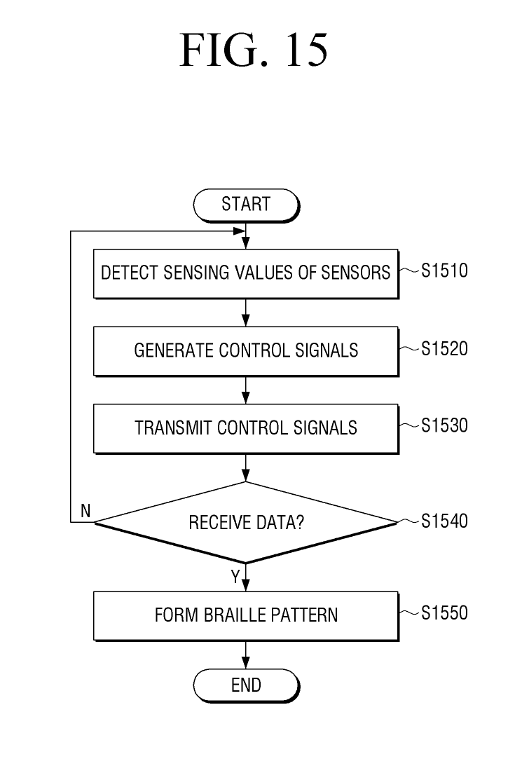

FIG. 15 is a flowchart explaining a control method of the wearable device 100 according to various exemplary embodiments. Referring to FIG. 15, the wearable device 100 detects sensing values of the sensor at operation S1510, and generates control signals according to the sensing values at operation S1520. The control signals may include digital code values which are constituted with 0 or 1.

The wearable device 100 transmits the generated control signals to the user terminal apparatus 200 at operation S1530. The user terminal apparatus 200 may perform various controlling operations according to the transmitted control signals. When data is generated according to the controlling operations or there is data to inform a user of, such as mail, messenger, update messages, schedule information, and text messages, the user terminal apparatus 200 may transmit the data to the wearable device 100.

At operation S1540, the wearable device 100 checks if data has been received. When the data is not received (operation S1540-N), the wearable device 100 performs Operations S1510-S1530 again. When the data is received (operation S1540-Y), the wearable device 100 forms a Braille pattern according to the received data at operation S1550. The method of forming the Braille pattern and the constitution of the wearable device 100 are specifically described in the above various exemplary embodiments, which will not be further explained.

Further, when determining that a user is encountering a risky situation, the wearable device 100 may provide vibration signals or alarm sounds to inform the user of the risky situation. Criteria to determine a risky situation may be determined with various methods as described above. Specifically, the control method may further include photographing the outside environment, determining risk factors based on the photographed image of the outside environment, and generating information regarding the determined risk factors.

Detailed explanation and other exemplary embodiments regarding operation of the wearable device 100 are specifically explained in the above relevant parts, which will not be further explained.

According to various exemplary embodiments of the present general inventive concept, even when a user is visually handicapped, he may utilize various functions of the user terminal apparatus 200 conveniently by using the wearable device 100. Therefore, convenience and security for the user are enhanced. Therefore, a user terminal apparatus can be utilized in various manners.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include a semiconductor memory, a read-only memory (ROM), a random-access memory (RAM), a USB memory, a memory card, a Blu-Ray disc, CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A wearable device in a glove shape that can be worn by a user body, the wearable device comprising:
a motion recognition sensor to recognize motion of the wearable device;
a bending sensor to sense bending of the wearable device;
a touch sensor to sense whether a touch is inputted or not;
a storage unit to store control codes corresponding to user motion;
a controller to determine a motion of a user wearing the wearable device based on sensing values of the motion recognition sensor, the bending sensor, and the touch sensor, and to generate control signals by using the control codes corresponding to the determined motion;
a communicator to transmit the control signals to a user terminal apparatus and receives data transmitted from the user terminal apparatus in response to the control signals; and
an actuator unit to form a Braille pattern according to the received data.

2. The wearable device of claim 1, wherein the actuator unit comprises a plurality of actuators that can be projected, and the actuator unit forms the Braille pattern by selectively projecting an actuator corresponding to the received data from among the plurality of actuators.

3. The wearable device of claim 2, wherein the Braille pattern comprises one or more Braille characters, and is formed according to a sliding manner in which each Braille character is consecutively formed and moved toward one direction, or a unit representation manner in which a plurality of the Braille characters are formed in a group.

4. The wearable device of claim 3, further comprising:
a side of the wearable device, the actuator unit being mounted on the side; and
wherein the controller controls the actuator unit to form the Braille pattern when the side on which the actuator unit is mounted touches an outer surface of an object.

5. The wearable device of claim 3, further comprising:
an output unit to output alarm sounds; and
a photographing unit to photograph an outside environment to generate an outside environment image,
wherein the controller determines risk factors based on the outside environment image, and controls the output unit or the actuator unit to provide information regarding the determined risk factors.

6. The wearable device of claim 1, further comprising:
a main body formed from flexible materials, the main body comprising a plurality of finger parts,
wherein the bending sensor is arranged on the plurality of finger parts respectively to sense a bending of each finger part,
wherein the touch sensor is arranged on the plurality of finger parts respectively to sense a touch situation of the finger part, and
wherein the actuator unit is arranged on finger tip parts of the plurality of finger parts or on a hand palm side of the main body.

7. The wearable device of claim 6, wherein the received data comprises at least one of a text message, SNS information, e-mail, absent call information, a schedule inform message, and an update message.

8. The wearable device of claim 7, further comprising:
an optical mouse formed on at least one of the finger tip parts,
wherein the controller transmits input signals inputted through the optical mouse to the user terminal apparatus.

9. A control method of a wearable device in a glove shape that can be worn by a user body, the control method comprising:
receiving sensing values of a motion recognition sensor, a bending sensor, and a touch sensor which are mounted on the wearable device;
generating control signals based on the sensing values;
transmitting the control signals to a user terminal apparatus;
receiving data transmitted from the user terminal apparatus in response to the control signals; and
forming a Braille pattern corresponding to the data by selectively projecting an actuator corresponding to the data from among a plurality of actuators mounted in the wearable device.

10. The control method of claim 9, wherein the Braille pattern comprises one or more Braille characters, and is formed according to a sliding manner in which each Braille character is consecutively formed and moved toward one direction, or a unit representation manner in which a plurality of the Braille characters are formed in a group.

11. The control method of claim 9, wherein the Braille pattern is formed in the wearable device, when a side of the wearable device on which the plurality of actuators is mounted touches an outer surface of an object.

12. The control method of claim 11, further comprising:
photographing an outside environment to generate an outside environment image;
determining risk factors based on the generated outside environment image; and
providing information regarding the determined risk factors.

13. The control method of claim 9, wherein the wearable device comprises a main body formed from flexible materials and comprising a plurality of finger parts,
wherein the bending sensor is arranged on the plurality of finger parts respectively to sense a bending of each finger part,
wherein the touch sensor is arranged on the plurality of finger parts to sense a touch situation of the finger, and
wherein the plurality of actuators are arranged on finger tip parts of the plurality of finger parts or on a hand palm side of the main body.

14. A non-transitory computer-readable medium to contain computer-readable codes as a program to execute the method of claim 9.

15. A wearable device configured to be worn by a user body, the wearable device comprising:
a sensor to detect motion of the wearable device and generate a sensor output corresponding to the detected motion;
a communication unit to transmit the sensor output to a user terminal apparatus and receive data transmitted from the user terminal apparatus in response to the sensor output; and
at least one actuator to form a Braille pattern in response to the data received from the user terminal apparatus.

16. The wearable device of claim 15, wherein the wearable device has a form of at least one of a glove, clothing, a shoe, glasses, and a hat.

17. The wearable device of claim 15, further comprising:
a controller to determine an elapsed time since the most recent motion of the user was determined, and to deactivate the wearable device if no motion of the user is determined within a preset time.

18. The wearable device of claim 15, further comprising:
a location determining unit to determine the location of the wearable device,
wherein the communicator transmits the determined location of the wearable device to the user terminal apparatus.

19. The wearable device of claim 18, wherein the communicator transmits the determined location of the wearable device to the user terminal apparatus when no user motion is determined within a preset time.

20. The wearable device of claim 15, further comprising:
a side of the wearable device, the at least one actuator being mounted on the side; and
a controller to control the at least one actuator to form the Braille pattern when the side on which the at least one actuator is mounted touches an outer surface of an object,
wherein the controller generates a user alert if the side on which the actuator unit is mounted does not touch the outer surface of the object within a preset time.
